(19) United States
(12) Patent Application Publication
(10) Pub. No.: US 2023/0297878 A1
(43) Pub. Date: Sep. 21, 2023

(54) METADATA-DRIVEN FEATURE STORE FOR MACHINE LEARNING SYSTEMS

(71) Applicant: C3.ai, Inc., Redwood City, CA (US)

(72) Inventors: David Tchankotadze, Saratoga, CA (US); Rohit P. Sureka, San Carlos, CA (US); Rahul Yadav, San Jose, CA (US); Siddharth Viswanathan, Foster City, CA (US); Jeffrey M. Fischer, Sunnyvale, CA (US)

(21) Appl. No.: 17/699,025

(22) Filed: Mar. 18, 2022

(51) Int. Cl. G06N 20/00; G06N 5/00

(52) U.S. Cl. CPC G06N 20/00; G06N 5/003

(57) ABSTRACT

A method includes identifying one or more transformations to be applied in order to generate one or more features or feature sets. The method also includes generating metadata identifying the one or more features or feature sets and the one or more transformations. The method further includes using the metadata to determine the one or more features or feature sets for specified data and storing the one or more determined features or feature sets in a feature store. In addition, the method includes outputting at least some of the one or more determined features or feature sets or data associated with the at least some of the one or more determined features or feature sets from the feature store to at least one machine learning model.

### TECHNICAL FIELD

This disclosure is generally directed to machine learning systems. More specifically, this disclosure is directed to a metadata-driven feature store for machine learning systems.

### BACKGROUND

Machine learning systems are being developed and deployed to perform numerous functions in computing systems and other systems. Many machine learning systems are designed using a process called feature engineering, which involves identifying the features to be used with a machine learning model. Features refer to data that is input into a trained machine learning model so that the trained machine learning model can perform inferencing using the features. The proper identification of features to be used with a machine learning model is often a critical or important aspect in the design of a system that uses machine learning.

### SUMMARY

This disclosure relates to a metadata-driven feature store for machine learning systems.

In a first embodiment, a method includes identifying one or more transformations to be applied in order to generate one or more features or feature sets. The method also includes generating metadata identifying the one or more features or feature sets and the one or more transformations. The method further includes using the metadata to determine the one or more features or feature sets for specified data and storing the one or more determined features or feature sets in a feature store. In addition, the method includes outputting at least some of the one or more determined features or feature sets or data associated with the at least some of the one or more determined features or feature sets from the feature store to at least one machine learning model.

In a second embodiment, an apparatus includes at least one processing device configured to identify one or more transformations to be applied in order to generate one or more features or feature sets. The at least one processing device is also configured to generate metadata identifying the one or more features or feature sets and the one or more transformations. The at least one processing device is further configured to use the metadata to determine the one or more features or feature sets for specified data and store the one or more determined features or feature sets in a feature store. In addition, the at least one processing device is configured to output at least some of the one or more determined features or feature sets or data associated with the at least some of the one or more determined features or feature sets from the feature store to at least one machine learning model.

In a third embodiment, a non-transitory computer readable medium stores computer readable program code that when executed causes one or more processors to identify one or more transformations to be applied in order to generate one or more features or feature sets. The medium also stores computer readable program code that when executed causes the one or more processors to generate metadata identifying the one or more features or feature sets and the one or more transformations. The medium further stores computer readable program code that when executed causes the one or more processors to use the metadata to determine the one or more features or feature sets for specified data and store the one or more determined features or feature sets in a feature store. In addition, the medium stores computer readable program code that when executed causes the one or more processors to output at least some of the one or more determined features or feature sets or data associated with the at least some of the one or more determined features or feature sets from the feature store to at least one machine learning model.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting a metadata-driven feature store according to this disclosure;

FIG. 2 illustrates an example device supporting a metadata-driven feature store according to this disclosure;

FIG. 3 illustrates an example architecture supporting a metadata-driven feature store according to this disclosure; and

FIGS. 4A and 4B illustrate an example method for using a metadata-driven feature store according to this disclosure.

### DETAILED DESCRIPTION

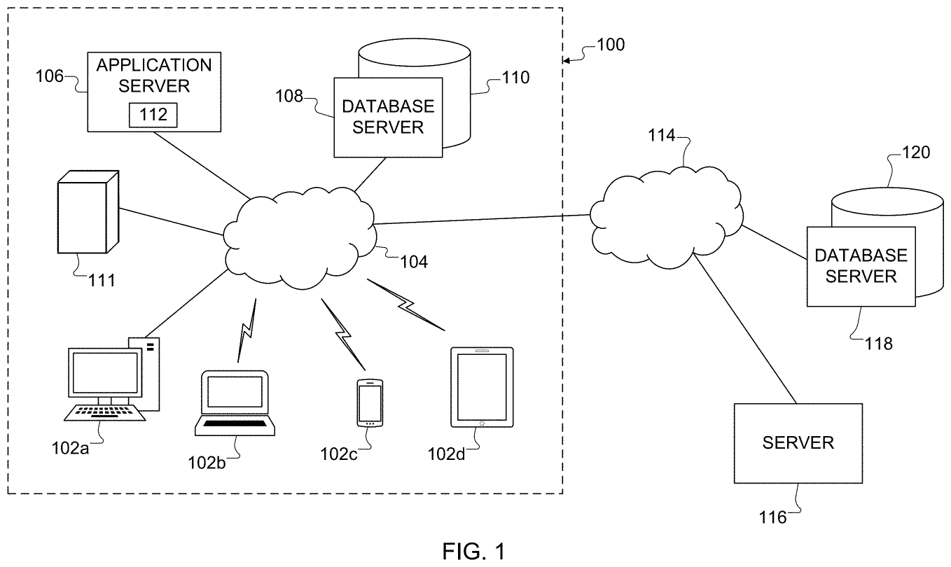

FIGS. 1 through 4B, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

The following definitions are provided for terms and phrases used in this disclosure. A “feature” refers to a single logical input or input sequence to be provided to a machine learning model. A feature can have an associated subject type, and an individual instance of a feature can be associated with a subject identifier (ID) and a value. A “subject type” refers to a category of person, place, or thing on which machine learning is to be applied. A “subject identifier” or “subject ID” refers to a unique identifier for a specific person, place, or thing on which machine learning is to be applied. A “time-series feature” refers to a feature that may vary for a specific subject ID over time. A time-series feature can have an associated timestamp for each instance of the time-series feature. An “interval” refers to an optional difference in time between subsequent timestamps for a time-series feature, which may be common in various circumstances (such as when a time-series feature represents a physical value that is sampled at a regular interval or in another manner). Sampled or discrete time-series features may be aggregated or resampled to a regular interval or other time(s).

A “data frame” refers to a tabular representation of data with rows and columns. Data frames are often used in data science as an in-memory representation, although data frames can be mapped to other types of data structures like relational database tables and record-oriented file representations (such as CSV, Parquet, ORC, ORC2, or HDF5 files). Data frames and database tables may be used interchangeably without a loss of generality. A “feature set” refers to a collection of features associated with the same machine learning subject type, where a feature set indicates how to combine multiple features to form a single data frame for input into a machine learning model. In addition to a list of features, a feature set may include a time interval, a pointer to a specific feature to be used when identifying the primary timestamp for the feature set, and one or more resampling functions that may be used to convert different time-series features to a common interval. Feature sets may be created explicitly by a user or implicitly, such as through actions performed on underlying data. A “point-in-time join” refers to an operation that combines features into a feature set such that, for each associated timestamp, all feature values represent the most-recent values for those features at or before the timestamp.

As noted above, many machine learning systems are designed using a process called feature engineering, which involves identifying the features to be used with a machine learning model. The proper identification of features to be used with a machine learning model is often a critical or important aspect in the design of a system that uses machine learning. Often times, the determination of the features to be input to a machine learning model involves identifying data transformations to be applied to available source data. Example types of data transformations that may be performed using available source data could include functions such as value mappings, value scaling, and data aggregations.

A feature may be said to be “materialized” when a transformed value for that feature is stored directly (rather than evaluating feature transformations on source data each time the data is used). A “feature store” refers to a centralized repository or other repository of materialized feature data. A feature store is typically used to support functions such as (i) the sharing and discoverability of features across teams of different personnel; (ii) the reuse of named features in both training and prediction (inferencing) contexts; and (iii) the providing of a point-in-time view of multiple features (like the most-recent version of each feature as of a specific point in time).

Feature stores routinely include two separate data storages, namely an offline storage and an online storage. The offline storage is generally used for storing data related to training of machine learning models, and the offline storage typically represents a file-based storage or a data warehouse. The online storage is generally used for storing data related to inferencing to be performed using trained machine learning models (often referred to as “production data”), and the online storage is typically implemented as an in-memory key-value store.

Typical feature stores are implemented as standalone components and are not metadata-driven. As a result, typical feature stores cannot provide much in the way of automation, and many required capabilities need to be manually implemented by end users. For instances, end users may need to define transitions from experimentation to production, re-computations of updated features, resampling of time-series features, and aggregation of composite features. End users are also often responsible for monitoring end-to-end data lineage and providing access control enforcement outside of the feature stores. In many cases, end users provide basic information about feature names and types, and the features are manually designed using Structured Query Language (SQL) code. Also, direct computations of features for in-memory inferencing are generally not possible with feature stores.

As a particular example of the type of process that may be followed using a typical feature store, data can be ingested from sources external to the feature store and stored within the offline storage. This is typically performed using custom code written by a developer (where the code is not managed by the feature store). The developer can also create registry entries corresponding to columns in tables within the offline storage. Historical features for machine learning model training can be obtained in batch mode, which is typically performed using SQL code written based on the offline storage's feature tables. A point-in-time join may be used to combine features from multiple tables within the offline storage. The most-recent data from the offline storage can be materialized into the online storage, such as by using SQL queries with point-in-time joins. A time-series feature or an externally-provided time-series feature can be used to define the points-in-time, which can also be stored in the online storage. For inferencing, the most recently-requested features can be obtained from the key-value store (the online storage) via an application programming interface (API) and provided to a machine learning model for use during inferencing.

Unfortunately, this type of approach can suffer from a number of shortcomings. For example, feature stores may not permit data transformations to be performed within the feature stores or may only permit minor data transformations to be performed within the feature stores. As a result, features often need to be transformed before they are ingested into a feature store, and most or all ingestion logic needs to be hand-built outside of the feature store. The ingestion logic also needs to be designed to work at scale, and there is typically no separate path for experimentation (without rewriting everything). Also, data experimentations and designing of machine learning models are typically performed using sample data stored in flat files (such as comma separated value or “CSV” format), and there is no path for reusing this work in a production feature store that may obtain its data from other types of sources (such as relational and time-series databases). Moreover, automatically recomputing features based on changes in upstream data is generally not possible since transformations happen outside of the feature store. Further, in many cases, different features may represent aggregations computed at different intervals, and combining these features using a point-in-time join can yield incorrect results. Existing feature stores are unable to perform the resampling needed to give correct results due to a lack of metadata. In addition, as a standalone component, a feature store is typically unable to track where individual data records originated from and where those data records are used, which means that end-to-end data lineage needs to be implemented outside of the feature store. Finally, the online storage of the feature store is typically populated from the most-recent features in the offline storage. Even though the online storage may provide low latency for inferencing, this means that the data may be stale due to the time it takes to ingest new data into the offline storage and propagate the new data into the online storage.

This disclosure provides various embodiments of metadata-driven feature stores for use with machine learning model-based systems. As described in more detail below, metadata (such as information defining transformations needed to create one or more features or feature sets from source data) can be created through an automated or manual process, such as through direct APIs calls. The metadata drives a process for efficiently computing and storing features or feature sets from both experimental data (meaning data used for designing, training, and evaluating one or more machine learning models) and production data (meaning data used for large-scale batch training and by one or more trained machine learning models during inferencing). The metadata is stored for use by a metadata-driven feature store, which can be tightly integrated with upstream and downstream processes of a machine learning workflow.

As particular examples of the functionality that can be supported by a metadata-driven feature store, the metadata-driven feature store can be used to capture and use metadata associated with features or feature sets being defined and determined using experimental data. For example, a system can allow one or more users to define individual features or feature sets to be determined using experimental data, and data transformations to be used to generate the features or feature sets can be defined. Metadata identifying the features or feature sets and the transformations can be captured and used to calculated values of the features or feature sets based on the experimental data, and the calculated features or feature sets can be materialized into the feature store in a suitable format. The features or feature sets stored in the feature store can be easily evaluated by one or more users and used to perform training of one or more machine learning models.

When production data becomes available, additional transformations between the production data and the features or feature sets defined using the experimental data may be identified. Additional metadata identifying the features or feature sets and the additional transformations can be captured and used to calculate values of the features or feature sets based on the production data, and the calculated features or feature sets can again be materialized into the feature store in a suitable format. Among other things, this approach allows the production data to be ingested and features or feature sets to be determined and stored in the feature store while having any needed changes applied to the production data, such as changes needed due to the production data representing aggregations or other information computed at different time intervals. In some cases, the feature store may optionally be populated directly from the incoming production data. In addition, new features or feature sets can easily be defined for the production data as needed.

In this way, a metadata-driven feature store can be used to allow transformations of data being ingested into the feature store, and these transformations can be built within the feature store itself, scaled as needed, and tested as needed. Also, the same types of data used for inferencing can be used during data experimentations and machine learning model design, which can help to facilitate easier and more accurate data experimentations and model designs. Moreover, features or feature sets can be recomputed as needed, and changes or corrections can be made to support point-in-time join operations for data associated with different time intervals. Further, a metadata-driven feature store can be used to track where individual data records originated from and where the data records are used, thereby supporting end-to-end data lineage within the feature store. In addition, a metadata-driven feature store can be used to more effectively and timely store production data since the production data does not need to first be transported through an offline storage. Finally, a metadata-driven feature store can provide a robust and scalable solution that allows users to quickly transition from experimentation to production and to avoid writing lots of custom code related to populating and updating the feature store.

FIG. 1 illustrates an example system 100 supporting a metadata-driven feature store according to this disclosure. For example, the system 100 shown here can be used to support a metadata-driven feature store that is used to store metadata related to features or feature sets to be processed by one or more machine learning models as described in more detail below. As shown in FIG. 1, the system 100 includes user devices 102a-102d, one or more networks 104, one or more application servers 106, and one or more database servers 108 associated with one or more databases 110 and/or one or more file servers 111. Each user device 102a-102d communicates over the network 104, such as via a wired or wireless connection. Each user device 102a-102d represents any suitable device or system used by at least one user to provide or receive information, such as a desktop computer, a laptop computer, a smartphone, and a tablet computer. However, any other or additional types of user devices may be used in the system 100.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. In some cases, the network 104 may include at least one network within a company or other organization that uses one or more machine learning models to perform one or more functions.

The application server 106 is coupled to the network 104 and is coupled to or otherwise communicates with the database server 108 and/or file server 111. The application server 106 and the database server 108, database 110, and/or file server 111 support the use of at least one metadata-driven feature store. For example, the application server 106 may execute one or more applications 112, and the application(s) 112 can be configured to define and use one or more metadata-driven feature stores. In some cases, the data of each metadata-driven feature store may be physically stored in the database 110 and accessed via the database server 108 and/or physically stored in the file server 111. Note that the database server 108 or file server 111 may also be used within the application server 106 to store information, in which case the application server 106 itself may store the information used to support one or more metadata-driven feature stores.

The database server 108 and/or the file server 111 operates to store and facilitate retrieval of various information used, generated, or collected by the application server 106 and the user devices 102a-102d in the database 110. For example, the database server 108 and/or the file server 111 may store data associated with one or more metadata-driven feature stores, such as a feature store that includes features or feature sets used by one or more machine learning models and metadata associated with those features or feature sets.

Note that in the system 100 of FIG. 1, it is assumed that the metadata-driven feature store(s) can be provided by the system 100 itself using the application server 106 and the database server 108 and database 110 and/or the file server 111. However, a metadata-driven feature store may be implemented in any other suitable manner. For example, the system 100 may be coupled to at least one external network 114, such as the Internet. This may allow at least one metadata-driven feature store for the organization associated with the system 100 to be created by a remote server 116, a cloud-based environment, or any other suitable device(s) outside or remote to the system 100. Data associated with the at least one metadata-driven feature store may also be stored by an external database server 118 in an external database 120, in an external file server, or in any other suitable manner. When implemented in this manner, multiple metadata-driven feature stores may be created and managed using the server 116 and have data stored in the database 120 and/or external file server on behalf of multiple systems 100, such as different systems 100 associated with different enterprises. In general, this disclosure is not limited to any particular implementation of or environment for one or more metadata-driven feature stores.

Although FIG. 1 illustrates one example of a system 100 supporting a metadata-driven feature store, various changes may be made to FIG. 1. For example, the system 100 may include any number of user devices 102a-102d, networks 104, 114, application servers 106, remote servers 116, database servers 108, 118, databases 110, 120, and file servers 111. Also, these components may be located in any suitable locations and might be distributed over a large area. In addition, while FIG. 1 illustrates one example operational environment in which one or more metadata-driven feature stores may be used, this functionality may be used in any other suitable system.

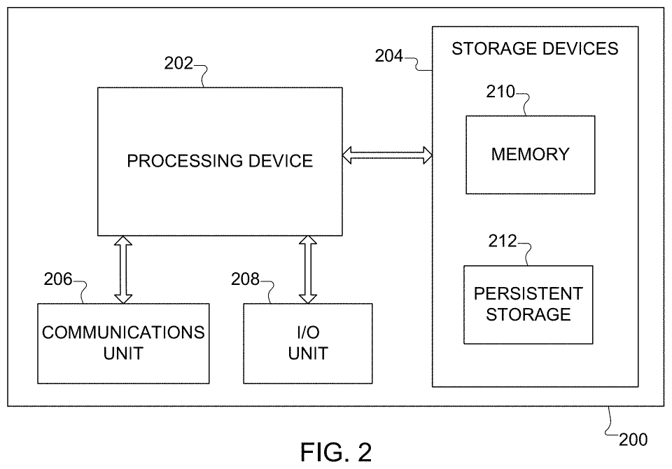

FIG. 2 illustrates an example device 200 supporting a metadata-driven feature store according to this disclosure. One or more instances of the device 200 may, for example, be used to at least partially implement the functionality of the application server 106, database server 108, and/or file server 111 of FIG. 1. However, the functionality of the application server 106, database server 108, and/or file server 111 may be implemented in any other suitable manner. In some embodiments, the device 200 shown in FIG. 2 may form at least part of a user device 102a-102d, although each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network, such as the network 104, 114. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

Although FIG. 2 illustrates one example of a device 200 supporting a metadata-driven feature store, various changes may be made to FIG. 2. For example, computing and communication devices and systems come in a wide variety of configurations, and FIG. 2 does not limit this disclosure to any particular computing or communication device or system.

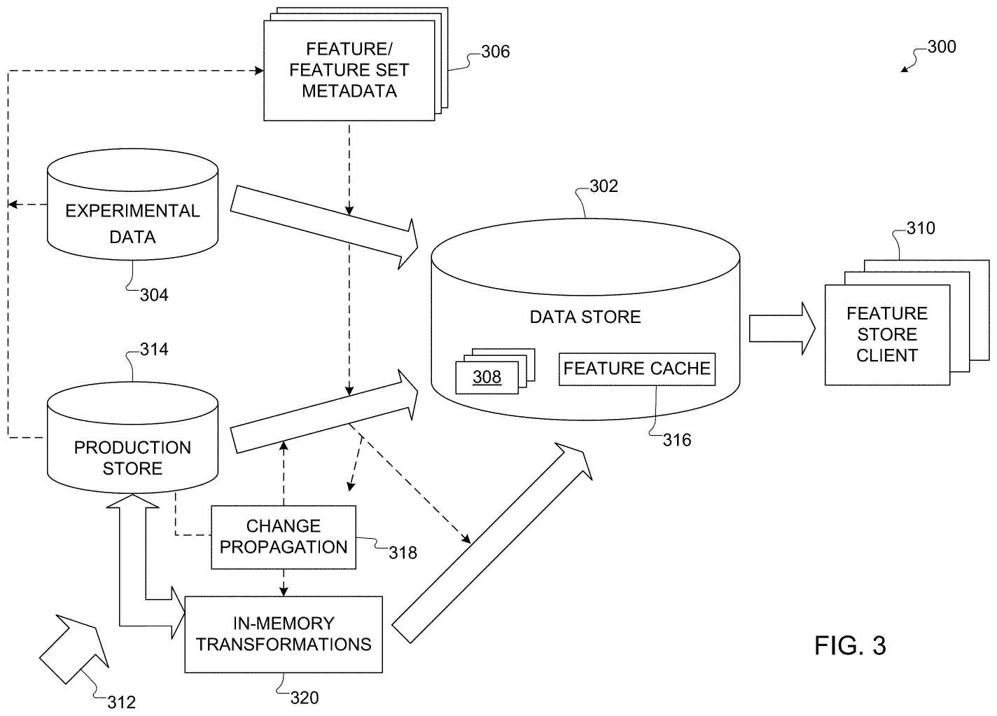

FIG. 3 illustrates an example architecture 300 supporting a metadata-driven feature store according to this disclosure. For ease of explanation, the architecture 300 shown in FIG. 3 is described as being implemented on or provided by the application server 106 and the database 110 and/or the file server 111 in the system 100 shown in FIG. 1, where the application server 106 may be implemented using one or more instances of the device 200 shown in FIG. 2. However, the architecture 300 shown in FIG. 3 could be implemented on or provided by any other suitable device(s) and in any other suitable system(s).

As shown in FIG. 3, the architecture 300 includes a data store 302, which represents a storage device (such as the database 110 and/or the file server 111) that can be used to store and retrieve various features or feature sets used by one or more machine learning models or other devices or systems. The types of features or feature sets stored in the data store 302 can vary widely based on the specific application(s) for the machine learning model(s). The data store 302 may be implemented in any suitable manner and may use any suitable technique(s) to store and retrieve information. As particular examples, the data store 302 may be implemented using a file store, a key-value store, an object storage service, or an SQL database. In general, this disclosure is not limited to any specific type(s) of database, file server, or other data storage technology. In some cases, the data store 302 may be implemented so as to have a low latency in order to enable rapidly throughput of data.

Using the architecture 300, data scientists or other personnel can have access to experimental data 304, which generally represents data that can be used for designing, training, and evaluating one or more machine learning models to perform at least one desired function. The experimental data 304 may be stored in any suitable location(s), such as within the database 110 and/or the file server 111. The experimental data 304 may also have any suitable form, such as when the experimental data 304 is defined using one or more data frames. A data scientist or other personnel can define one or more features or feature sets to be generated using at least some of the experimental data 304 and identify one or more transformations to be applied to that experimental data 304 in order to produce the feature(s) or feature set(s). Any suitable transformations used to generate features or feature sets may be identified here, such as mappings of experimental data 304 to feature values, scaling of experimental data 304 to feature values, or aggregations of experimental data 304 to create feature values. The transformations may be explicitly specified or implicitly identified, such as by tracking the personnel's actions taken on the experimental data 304 using an interactive API (like the Pandas API or the SQL API).

The identified features or feature sets and the identified transformations are used to define or generate feature/feature set metadata 306. The metadata 306 generally defines one or more features or feature sets to be generated and one or more transformations that are performed to generate the one or more features or feature sets from source data. For example, the metadata 306 may include names and data types for the defined features or feature sets. The metadata 306 may also include user-supplied metadata, such as a user-supplied description of each of one or more features or feature sets. The metadata 306 may further include information defining the transformations that are performed to generate feature values of the features or feature sets using the experimental data 304. The transformations can be represented in any suitable manner within the metadata 306, such as in a manner in which it is easy to determine the source rows and columns of the experimental data 304 whose values may impact each feature's value. If a feature is a time-series feature, a desired aggregation interval (if any) can also be stored as part of the metadata 306 for that feature.

Upon request or in response to any other suitable trigger, features or feature sets can be determined using the experimental data 304 (such as in accordance with the metadata 306) and can be materialized into the data store 302. In general, each materialization operation involves storing the features or feature sets identified using the experimental data 304 into the data store 302 as stored features 308. The stored features 308 may include features stored in any suitable manner, such as in files or relational database tables. For instance, in some embodiments, files containing the stored features 308 may be partitioned (such as via range or hash) according to one or more criteria, such as one, some, or all of the following criteria: subject type, subject ID, feature name, time range for the feature values, and the feature values themselves. In other embodiments, the data store 302 may represent an SQL database, and each feature or feature set may be stored in a table.

Once stored features 308 are available in the data store 302, various features and feature sets can be evaluated by personnel, such as by querying the data store 302 via an API or other mechanism and receiving selected features 308 from the data store 302. The selected features 308 identified for evaluation (or a portion of the data associated with the selected features 308) may be exported, such as to one or more machine learning models represented as clients 310 of the data store 302. The selected features 308 identified for evaluation may also be exported in any suitable form, such as in one or more data frames. For example, each evaluation may include querying the data store 302 for stored features 308 satisfying one or more specified criteria and obtaining a data frame containing those stored features 308. Each data frame may be suitable for input into a machine learning model or client 310. As a particular example, the data store 302 may be queried by providing a request that identifies a list of feature names or a feature set name, an optional filter condition for subject IDs, and an optional timestamp range. Stored features 308 that satisfy this request (or a portion of the data associated with the stored features 308 that satisfy this request) can be identified, merged, and output as a data frame. Note that, when evaluating a feature set, a desired time interval can be provided in a query for the data store 302, and individual stored features 308 satisfying the query may be resampled if they do not match the current interval. A point-in-time join can also be performed across the features in the feature set in order to produce the query results (such as a data frame for the feature set). Also note that if the data store 302 is an SQL database, an SQL query with suitable evaluation conditionals can be used to retrieve selected features 308.

This approach allows the experimental data 304 to be used to identify various features 308, which can be stored, analyzed, tested, and adjusted as needed or desired. Moreover, this approach may allow the features 308 to be defined and generated using the same type(s) of data that can be obtained during inferencing, meaning the experimental data 304 need not be a flat file and could represent data from one or more relational or time-series databases (although the experimental data 304 could still be flat). In addition, as can be seen here, the data store 302 can allow changes or corrections to be made to information in order to support operations such as point-in-time join operations for data associated with different time intervals.

At some point, production data 312 can become available for use, and the production data 312 may be stored in at least one production store 314. The production data 312 may be stored in any suitable location(s), such as within the database 110 and/or the file server 111 implementing the production store(s) 314. The production data 312 can represent data that is to be used for large-scale training of machine learning models and/or provided to one or more trained machine learning models (such as one or more clients 310) for use during inferencing. It is possible (and rather common) for the production data 312 to differ from the experimental data 304 in at least one way, such as in terms of formatting or content. As a result, one or more additional transformations can be defined for generating, based on the production data 312, the same features or feature sets defined earlier for the experimental data 304. Note that the one or more additional transformations may be created manually (such as by a data scientist or other personnel) or inferred, such as based on operations invoked by the personnel using the production data 312. In whatever manner the one or more additional transformations are identified, the features or feature sets to be generated and the additional transformations to be used to generate those features or feature sets using the production data 312 can be used to define or generate additional feature/feature set metadata 306. Again, the additional metadata 306 may include names and data types for the defined features or feature sets, any user-supplied metadata, and information defining the transformations that are performed to generate feature values of the features or feature sets using the production data 312. The additional transformations can be represented in any suitable manner within the additional metadata 306, such as in a manner in which it is easy to determine the source rows and columns of the production data 312 whose values may impact each feature's value.

After some of the production data 312 is loaded into the production store 314, features or feature sets can be determined using the production data 312 (such as in accordance with the additional metadata 306) and can be materialized into the data store 302. This allows the features or feature sets based on the production data 312 to be stored in the data store 302 as additional stored features 308. One or more clients 310 (such as one or more trained machine learning models) can use the same API calls or other queries that were used earlier during evaluation of the stored features 308 for the experimental data 304 in order to obtain selected stored features 308 for the production data 312 (such as in the form of data frames) and to process those features 308. In some cases, an optional feature cache 316 may be used to store a subset of the data store's stored features 308 for faster access by one or more of the clients 310.

As new production data 312 arrives, the production store 314 can be updated with the new data. A change propagation function 318 can be used here to determine whether any of the new production data 312 (and associated time ranges) need to be updated, such as when intervals of the new production data 312 do not match. In some cases, the change propagation function 318 may determine whether new production data 312 needs to be adjusted based on the specific incoming production data 312 received and dependency mappings in the metadata 306. If changes are needed, the change propagation function 318 can resample at least some of the new production data 312 to the appropriate time(s). The change propagation function 318 may use any suitable technique here to identify and resample data. In some embodiments, for instance, the change propagation function 318 may be implemented using the ANALYTICS CONTAINER ENGINE (ACE) from C3.AI, INC.

In some cases, it is also possible to perform one or more in-memory transformations 320 to at least some of the production data 312 in order to produce additional features or feature sets directly from the production data 312. These features or feature sets can similarly be materialized for storage as features 308 in the data store 302 or for storage in the feature cache 316 (for low latency processing). Additional metadata 306 may be generated and used to implement the processing performed by the in-memory transformations 320. If needed, the change propagation function 318 can be used to modify at least some of the production data 312 being processed by the one or more in-memory transformations 320 in order to account for different time intervals.

In addition, at certain times after production data 312 is being received and processed, it may become necessary or desirable to define and use one or more additional features or feature sets based on the production data 312. This can include modified versions of previously-defined features or feature sets or new features or feature sets. In those cases, the one or more additional features or feature sets and their associated transformations may be defined, and additional metadata 306 associated with those additional features or feature sets and associated transformations can be generated. The one or more additional features or feature sets can be determined using the production data 312 (such as in accordance with the additional metadata 306) and can be materialized into the data store 302 so that additional features 308 can be placed in the data store 302 and provided to one or more machine learning models or clients 310.

In this way, metadata 306 can be used to define the transformations that are applied in order to generate and update features 308 stored in the data store 302. It is also possible for users to use the metadata 306 to infer the lineage of information passing through the data store 302, and at least some metadata 306 that is defined can actually identify the specific client(s) 310 for which specific features 308 are being determined. In addition, it is easy for users to transition between experimentation and production modes of operation, meaning the users can easily switch between designing features for use by machine learning models and computing those features for analysis by the machine learning models.

There are a variety of other functions that may be implemented within or using the architecture 300 of a feature store as shown in FIG. 3. For example, the architecture 300 can be configured to capture snapshots of features 308 within the data store 302. A snapshot represents the state of a feature or feature set at a specific point in time. In some cases, it may be desirable to capture a snapshot of features when training a machine learning model since the snapshot can then be used to train other models, ensuring that the models are trained on the exact same data. When using machine learning models in certain industries (such as finance), it may be legally required to retain the snapshot for auditing purposes. The metadata-driven design of the feature store makes it easy to capture and leverage feature snapshots.

One example process for capturing feature or feature set snapshots may be performed as follows. When a feature or feature set is queried from the feature store 302 by a client 310, the client 310 may provide a query, such as one with a list of subject IDs (or a filter expression to generate that list) and a time range. The process described above can be used to identity the subset of the stored feature data in the data store 302 satisfying the query. The stored feature data satisfying the query may be copied to another location in the data store 302. Various approaches for copying the stored features 308 may be used. In some cases, an entire data file set can be copied as-is to the new location, and (although this may contain extra data not part of the original query like when a file contains a longer time range than requested) the metadata generated as described below can be used to filter data outside the range of the snapshot. In other cases, the stored feature data satisfying the query can be merged and rewritten as a new copy in an optimized format, such as by just including the data that satisfies the query. In still other cases, if prior snapshots have any identical files, only one copy of the common files may need to be kept, and each snapshot could maintain a reference to these files. A combination of these approaches may also be used. In whatever manner the copy is produced, a metadata entry for the snapshot can be added to the metadata 306 for the associated feature or feature set, and this metadata entry can provide information about the snapshot (such as the original filter conditions for the snapshot, the snapshot timestamp, and bidirectional links between the snapshot and the metadata of features or feature sets included in the snapshot). An export command allows the data from the snapshot to be copied to an external location (such as an object storage bucket), and the external copy can be archived or used independently of the feature store 302. Future feature requests from clients 310 can specify this snapshot, and (by using the snapshot metadata) data can be returned from the snapshot instead of the feature store 302.

As another example function that may be implemented, business requirements or other requirements may dictate that certain data in a production store 314 cannot be disclosed to unauthorized users. An access control layer (such as one based on a role-based access control model) may be implemented in the production store 314 to meet these requirements. The same requirements may generally apply to the transformed data (features 308) retrieved from the feature store 308 by clients 310. In existing systems, a user may need to manually configure an access control system for a feature store and manually reimplement all existing access rules on the feature data. With the feature store shown in FIG. 3, the transformations identified by the metadata 306 can be used to create a mapping from rows and columns in the production store 314 to features 308 in the feature store 302 and vice versa. This may be similar to a mapping created to determine change propagation. Using these mappings, access control settings from the production store 314 can be used to infer access control settings for features 308 in the feature store 302. One example of this may occur as follows.

Given a feature 308 (and optionally a list of subjects), a mapping may be used to determine the rows and columns in the production store 314 used to create the feature 308. The access settings of the mapped rows and columns in the production store 314 can be identified, and this can be referred to as the source access control set. An access control setting can be found that is as restrictive as or more restrictive than all settings in the access control set. For instance, a partial ordering of all access rights may be created, where the lowest access right can represent no access and the highest access right can represent access to everyone. The highest access level that is equal to or lower than all access settings in the source access control set can be selected, and the selected access level can be applied to the feature 308 (and possibly to its subject list). Optionally, a user can manually override the computed access control settings for the features 308, which may be useful for cases where the computed setting turns out to be too restrictive or not necessary (such as when a given feature 308 has been anonymized with respect to the original source data).

Note that the functions shown in or described with respect to FIG. 3 can be implemented in an electronic device, such as a computing device, in any suitable manner. For example, in some embodiments, at least some of the functions shown in or described with respect to FIG. 3 can be implemented or supported using one or more software applications or other software instructions that are executed by one or more processing devices of an application server 106, database server 108, file server 111, device 200, or other device. In other embodiments, at least some of the functions shown in or described with respect to FIG. 3 can be implemented or supported using dedicated hardware components. In general, the functions shown in or described with respect to FIG. 3 can be performed using any suitable hardware or any suitable combination of hardware and software/firmware instructions.

Also note that various functions described above with respect to FIG. 3 may be implemented in a number of ways. For example, the identification of transformations to be applied to experimental data 304 or production data 312 may occur in any suitable manner, and metadata 306 defining the transformations may be expressed in any suitable manner. As a particular example, U.S. patent application Ser. No. 17/698,934 (Docket No. CAII01-00011) entitled “INTELLIGENT DATA PROCESSING SYSTEM WITH MULTI-INTERFACE FRONTEND AND BACKEND” (which is hereby incorporated by reference in its entirety) describes how data transformations may be identified and used to generate directed acyclic graphs that represent those data transformations. The same or similar mechanisms may be used here to track how transformations are to be applied to experimental data 304 or production data 312 and to record information defining those transformations. However, any other suitable approaches may be used here. In addition, note that the metadata 306 may be stored in any suitable storage location(s), such as a production store 314, a data store 302, a database 110, or a file server 111.

Finally, note that it is assumed in FIG. 3 that experimental data 304 is used to define features or feature sets and their associated transformations and then production data 312 is obtained and used to generate those features or feature sets (possibly using different transformations). However, the use of experimental data 304 is not required. As a result, the same operations and processes described above with respect to the experimental data 304 may actually be performed using production data 312, meaning features or feature sets and their associated transformations may be defined using the production data 312.

Although FIG. 3 illustrates one example of an architecture 300 supporting a metadata-driven feature store, various changes may be made to FIG. 3. For example, functions and components can be added, omitted, combined, further subdivided, replicated, or placed in any other suitable configuration in the architecture 300 according to particular needs. As a particular example, the architecture 300 may include any suitable number of data stores and be used by any suitable number of clients.

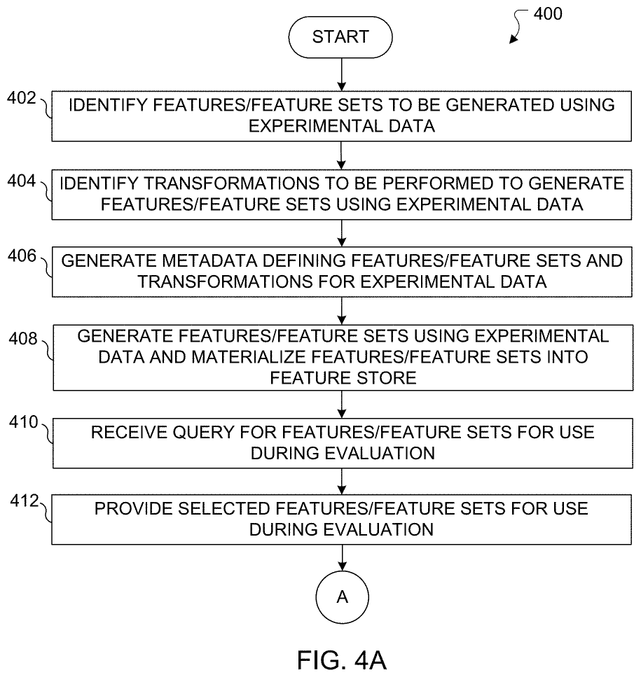

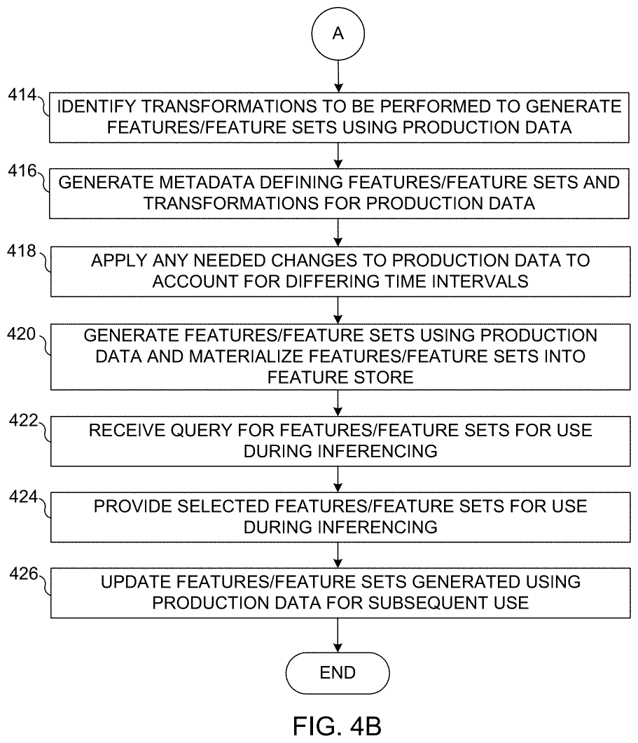

FIGS. 4A and 4B illustrate an example method 400 for using a metadata-driven feature store according to this disclosure. For ease of explanation, the method 400 shown in FIGS. 4A and 4B is described as being performed using the application server 106 and the database 110 and/or the file server 111 in the system 100 shown in FIG. 1, where the application server 106 may be implemented using one or more instances of the device 200 shown in FIG. 2. However, the method 400 shown in FIGS. 4A and 4B could be performed using any other suitable device(s) and in any other suitable system(s).

As shown in FIGS. 4A and 4B, one or more features or feature sets to be generated using experimental data are identified at step 402, and one or more transformations to be performed to generate the one or more features or feature sets using the experimental data are identified at step 404. This may include, for example, the processing device 202 of the application server 106 allowing a user to identify experimental data 304 to be used and one or more features or feature sets to be generated using that experimental data 304. This may also include the processing device 202 of the application server 106 allowing the user to identify or invoke one or more transformations to be applied to the experimental data 304 in order to generate the feature(s) or feature set(s). Metadata associated with the one or more features or feature sets and the one or more transformations is generated at step 406. This may include, for example, the processing device 202 of the application server 106 generating metadata 306 identifying the feature(s)/feature set(s) and the transformation(s). The one or more transformations are performed to generate the one or more features or feature sets using the experimental data, and the one or more features or feature sets are materialized into a feature store at step 408. This may include, for example, the processing device 202 of the application server 106 performing the transformation(s) using the experimental data 304 as defined by the metadata 306 in order to generate the feature(s) or feature set(s). Note that this assumes the features or feature sets were not produced earlier when the transformations were being defined, which may occur in some cases. This may also include the processing device 202 of the application server 106 storing the feature(s)/feature set(s) as stored features 308 in the data store 302.

At least one query for one or more features or feature sets to be used for evaluation is received at step 410. This may include, for example, the processing device 202 of the application server 106 receiving a query from a client 310 for stored features 308 in the data store 302 matching one or more specified criteria. One or more selected features or feature sets are provided for use during the evaluation at step 412. This may include, for example, the processing device 202 of the application server 106 retrieving one or more of the stored features 308 from the data store 302 based on the criterion or criteria in the query and providing the retrieved feature(s)/feature set(s) in a data frame. The retrieved information may be used in any suitable manner during the evaluation. If desired, various ones of steps 402-412 may be repeated based on the results of the evaluation or for any other suitable reason, such as to alter the feature(s) or feature set(s). Among other things, this may allow users to review features or feature sets generated using the experimental data 304 and adjust the features or feature sets as needed or desired (such as by modifying or deleting existing features/feature sets or adding new features/feature sets).

At some point, production data for use during inferencing can be obtained, such as when production data 312 is obtained from any suitable source(s) and optionally stored in at least one production store 314. One or more transformations to be performed to generate the one or more features or feature sets using the production data are identified at step 414. This may include, for example, the processing device 202 of the application server 106 allowing the user to identify or invoke one or more transformations to be applied to the production data 312 in order to generate the same feature(s) or feature set(s) previously defined for the experimental data 304. Metadata associated with the one or more features or feature sets and the one or more transformations is generated at step 416. This may include, for example, the processing device 202 of the application server 106 generating additional metadata 306 identifying the feature(s)/feature set(s) and the transformation(s) for the production data 312. If necessary, one or more changes can be implemented to the production data at step 418. This may include, for example, the processing device 202 of the application server 106 performing the change propagation function 318 in order to resample one or more portions of the production data 312 associated with a different time interval than one or more other portions of the production data 312. The one or more transformations are performed to generate the one or more features or feature sets using the production data or modified production data, and the one or more features or feature sets are materialized into the feature store at step 420. This may include, for example, the processing device 202 of the application server 106 performing the transformation(s) using the production data 304 as defined by the additional metadata 306 in order to generate the feature(s) or feature set(s). The one or more transformations can be performed here using the production data 312 within the production store 314, using one or more in-memory transformations 320, or in any other suitable manner. This may also include the processing device 202 of the application server 106 storing the feature(s)/feature set(s) as additional stored features 308 in the data store 302.

At least one query for one or more features or feature sets to be used for inferencing is received at step 422. This may include, for example, the processing device 202 of the application server 106 receiving a query from a client 310 for stored features 308 in the data store 302 matching the one or more specified criteria defined earlier while using the features 308 of the experimental data 304. The stored features 308 being sought here for inferencing represent features produced using the production data 312. One or more selected features or feature sets are provided for use during the inferencing at step 424. This may include, for example, the processing device 202 of the application server 106 retrieving one or more of the stored features 308 from the data store 302 and providing the retrieved feature(s)/feature set(s) in a data frame. The retrieved information may be used in any suitable manner during the inferencing.

Optionally, there may come a time when one or more features or feature sets used with the production data 312 need to be updated or removed or one or more features or feature sets need to be added for use with the production data 312. If so, the one or more features or feature sets used with the production data can be updated and additional metadata can be generated for use at step 426. This may include, for example, the processing device 202 of the application server 106 allowing a user to alter the feature(s) or feature set(s) used with the production data 312 or to create new feature(s) or feature set(s) for use with the production data 312. This may also include the processing device 202 of the application server 106 allowing the user to identify one or more transformations to be used to generate the updated feature(s) or feature set(s). This may further include the processing device 202 of the application server 106 generating additional metadata 306 associated with the updated feature(s) or feature set(s) and related transformation(s).

Although FIGS. 4A and 4B illustrate one example of a method 400 for using a metadata-driven feature store, various changes may be made to FIGS. 4A and 4B. For example, while shown as a series of steps, various steps in FIGS. 4A and 4B may overlap, occur in parallel, occur in a different order, or occur any number of times. Also, as noted above, various steps described as being performed using the experimental data 304 may instead be performed using the production data 312.

The following describes example embodiments of this disclosure that implement a metadata-driven feature store for machine learning systems. However, other embodiments may be used in accordance with the teachings of this disclosure.

In a first embodiment, a method includes identifying one or more transformations to be applied in order to generate one or more features or feature sets. The method also includes generating metadata identifying the one or more features or feature sets and the one or more transformations. The method further includes using the metadata to determine the one or more features or feature sets for specified data and storing the one or more determined features or feature sets in a feature store. In addition, the method includes outputting at least some of the one or more determined features or feature sets or data associated with the at least some of the one or more determined features or feature sets from the feature store to at least one machine learning model.

In a second embodiment, an apparatus includes at least one processing device configured to identify one or more transformations to be applied in order to generate one or more features or feature sets. The at least one processing device is also configured to generate metadata identifying the one or more features or feature sets and the one or more transformations. The at least one processing device is further configured to use the metadata to determine the one or more features or feature sets for specified data and store the one or more determined features or feature sets in a feature store. In addition, the at least one processing device is configured to output at least some of the one or more determined features or feature sets or data associated with the at least some of the one or more determined features or feature sets from the feature store to at least one machine learning model.

In a third embodiment, a non-transitory computer readable medium stores computer readable program code that when executed causes one or more processors to identify one or more transformations to be applied in order to generate one or more features or feature sets. The medium also stores computer readable program code that when executed causes the one or more processors to generate metadata identifying the one or more features or feature sets and the one or more transformations. The medium further stores computer readable program code that when executed causes the one or more processors to use the metadata to determine the one or more features or feature sets for specified data and store the one or more determined features or feature sets in a feature store. In addition, the medium stores computer readable program code that when executed causes the one or more processors to output at least some of the one or more determined features or feature sets or data associated with the at least some of the one or more determined features or feature sets from the feature store to at least one machine learning model.

Any single one or any suitable combination of the following features may be used with the first, second, or third embodiment. The one or more transformations to be applied may represent one or more transformations to be applied to experimental data in order to generate the one or more features or feature sets for the experimental data. The at least some of the one or more determined features or feature sets or the data associated with the at least some of the one or more determined features or feature sets may be output for evaluation. The one or more transformations may include one or more first transformations, and the metadata may include first metadata. One or more second transformations to be applied in order to generate the one or more features or feature sets for production data may be identified, second metadata identifying the one or more features or feature sets and the one or more second transformations may be generated, and the second metadata may be used to determine the one or more features or feature sets for the production data. The one or more second determined features or feature sets may be stored in the feature store, and at least some of the one or more second determined features or feature sets or data associated with the at least some of the one or more second determined features or feature sets may be output for inferencing. A query for determined features or feature sets stored in the feature store may be received, and any determined features or feature sets matching one or more criteria specified in the query or data associated with any determined features or feature sets matching the one or more criteria specified in the query may be output. A determination whether portions of the specified data are associated with different time intervals can be made, and at least one portion of the specified data may be resampled to time intervals associated with at least one other portion of the specified data. The metadata may be used to determine the one or more features or feature sets for the specified data by performing one or more in-memory transformations, and the one or more determined features or feature sets may be stored in a feature cache of the feature store. One or more additional transformations to be applied in order to generate one or more additional features or feature sets may be identified, additional metadata identifying the one or more additional features or feature sets and the one or more additional transformations may be generated, and the additional metadata may be used to determine the one or more additional features or feature sets for additional specified data. The one or more determined additional features or feature sets may be stored in the feature store, and at least some of the one or more additional determined features or feature sets or data associated with the at least some of the one or more additional determined features or feature sets may be output from the feature store. A snapshot of a specified one of the one or more features or feature sets in the feature store identified as satisfying a query can be generated, the snapshot may be stored in the feature store, and a metadata entry identifying the snapshot in the metadata associated with the specified feature or feature set may be generated. An access control set associated with a portion of the specified data used to produce a specified one of the one or more features or feature sets may be identified, and an access control setting for the specified feature or feature set in the feature store may be identified (the access control setting may be as restrictive as or more restrictive than all settings in the access control set).

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrases “at least one of” and “one or more of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
identifying one or more transformations to be applied in order to generate one or more features or feature sets;
generating metadata identifying the one or more features or feature sets and the one or more transformations;
using the metadata to determine the one or more features or feature sets for specified data;
storing the one or more determined features or feature sets in a feature store; and
outputting at least some of the one or more determined features or feature sets or data associated with the at least some of the one or more determined features or feature sets from the feature store to at least one machine learning model.

2. The method of claim 1, wherein:
the one or more transformations to be applied represent one or more transformations to be applied to experimental data in order to generate the one or more features or feature sets for the experimental data; and
the at least some of the one or more determined features or feature sets or the data associated with the at least some of the one or more determined features or feature sets are output for evaluation.

3. The method of claim 2, wherein:
the one or more transformations comprise one or more first transformations;
the metadata comprises first metadata; and
the method further comprises:
identifying one or more second transformations to be applied in order to generate the one or more features or feature sets for production data;
generating second metadata identifying the one or more features or feature sets and the one or more second transformations;
using the second metadata to determine the one or more features or feature sets for the production data;
storing the one or more second determined features or feature sets in the feature store; and
outputting at least some of the one or more second determined features or feature sets or data associated with the at least some of the one or more second determined features or feature sets for inferencing.

4. The method of claim 1, further comprising:
receiving a query for determined features or feature sets stored in the feature store;
wherein outputting the at least some of the one or more determined features or feature sets or the data associated with the at least some of the one or more determined features or feature sets comprises outputting any determined features or feature sets matching one or more criteria specified in the query or data associated with any determined features or feature sets matching the one or more criteria specified in the query.

5. The method of claim 1, further comprising:
determining whether portions of the specified data are associated with different time intervals; and
resampling at least one portion of the specified data to time intervals associated with at least one other portion of the specified data.

6. The method of claim 1, wherein:
using the metadata to determine the one or more features or feature sets for the specified data comprises performing one or more in-memory transformations; and
storing the one or more determined features or feature sets comprises storing the one or more determined features or feature sets in a feature cache of the feature store.

7. The method of claim 1, further comprising:
identifying one or more additional transformations to be applied in order to generate one or more additional features or feature sets;
generating additional metadata identifying the one or more additional features or feature sets and the one or more additional transformations;
using the additional metadata to determine the one or more additional features or feature sets for additional specified data;
storing the one or more determined additional features or feature sets in the feature store; and
outputting at least some of the one or more additional determined features or feature sets or data associated with the at least some of the one or more additional determined features or feature sets from the feature store.

8. The method of claim 1, further comprising:
generating a snapshot of a specified one of the one or more features or feature sets in the feature store identified as satisfying a query;
storing the snapshot in the feature store; and
generating a metadata entry identifying the snapshot in the metadata associated with the specified feature or feature set.

9. The method of claim 1, further comprising:
identifying an access control set associated with a portion of the specified data used to produce a specified one of the one or more features or feature sets; and
identifying an access control setting for the specified feature or feature set in the feature store, the access control setting being as restrictive as or more restrictive than all settings in the access control set.

10. An apparatus comprising:
at least one processing device configured to:
identify one or more transformations to be applied in order to generate one or more features or feature sets;
generate metadata identifying the one or more features or feature sets and the one or more transformations;
use the metadata to determine the one or more features or feature sets for specified data;
store the one or more determined features or feature sets in a feature store; and
output at least some of the one or more determined features or feature sets or data associated with the at least some of the one or more determined features or feature sets from the feature store to at least one machine learning model.

11. The apparatus of claim 10, wherein:
the one or more transformations to be applied represent one or more transformations to be applied to experimental data in order to generate the one or more features or feature sets for the experimental data; and
the at least one processing device is configured to output the at least some of the one or more determined features or feature sets or the data associated with the at least some of the one or more determined features or feature sets for evaluation.

12. The apparatus of claim 11, wherein:
the one or more transformations comprise one or more first transformations;
the metadata comprises first metadata; and
the at least one processing device is further configured to:
identify one or more second transformations to be applied in order to generate the one or more features or feature sets for production data;
generate second metadata identifying the one or more features or feature sets and the one or more second transformations;
use the second metadata to determine the one or more features or feature sets for the production data;
store the one or more second determined features or feature sets in the feature store; and
output at least some of the one or more second determined features or feature sets or data associated with the at least some of the one or more second determined features or feature sets for inferencing.

13. The apparatus of claim 10, wherein:
the at least one processing device is further configured to receive a query for determined features or feature sets stored in the feature store; and
to output the at least some of the one or more determined features or feature sets, the at least one processing device is configured to output any determined features or feature sets matching one or more criteria specified in the query or data associated with any determined features or feature sets matching the one or more criteria specified in the query.

14. The apparatus of claim 10, wherein the at least one processing device is further configured to:
determine whether portions of the specified data are associated with different time intervals; and
resample at least one portion of the specified data to time intervals associated with at least one other portion of the specified data.

15. The apparatus of claim 10, wherein:
the at least one processing device is configured to perform one or more in-memory transformations in order to use the metadata to determine the one or more features or feature sets for the specified data; and
the at least one processing device is configured to store the one or more determined features or feature sets in a feature cache of the feature store.

16. The apparatus of claim 10, wherein the at least one processing device is further configured to:
identify one or more additional transformations to be applied in order to generate one or more additional features or feature sets;
generate additional metadata identifying the one or more additional features or feature sets and the one or more additional transformations;
use the additional metadata to determine the one or more additional features or feature sets for additional specified data;
store the one or more determined additional features or feature sets in the feature store; and
output at least some of the one or more additional determined features or feature sets or data associated with the at least some of the one or more additional determined features or feature sets from the feature store.

17. A non-transitory computer readable medium storing computer readable program code that when executed causes one or more processors to:
identify one or more transformations to be applied in order to generate one or more features or feature sets;
generate metadata identifying the one or more features or feature sets and the one or more transformations;
use the metadata to determine the one or more features or feature sets for specified data;
store the one or more determined features or feature sets in a feature store; and
output at least some of the one or more determined features or feature sets or data associated with the at least some of the one or more determined features or feature sets from the feature store to at least one machine learning model.

18. The non-transitory computer readable medium of claim 17, wherein:
the one or more transformations to be applied represent one or more transformations to be applied to experimental data in order to generate the one or more features or feature sets for the experimental data; and
the computer readable program code that when executed causes the one or more processors to output the at least some of the one or more determined features or feature sets or the data associated with the at least some of the one or more determined features or feature sets comprises:
computer readable program code that when executed causes the one or more processors to output the at least some of the one or more determined features or feature sets or the data associated with the at least some of the one or more determined features or feature sets for evaluation.

19. The non-transitory computer readable medium of claim 18, wherein:
the one or more transformations comprise one or more first transformations;
the metadata comprises first metadata; and
the medium further stores computer readable program code that when executed causes the one or more processors to:
identify one or more second transformations to be applied in order to generate the one or more features or feature sets for production data;
generate second metadata identifying the one or more features or feature sets and the one or more second transformations;
use the second metadata to determine the one or more features or feature sets for the production data;
store the one or more second determined features or feature sets in the feature store; and
output at least some of the one or more second determined features or feature sets or data associated with the at least some of the one or more second determined features or feature sets for inferencing.

20. The non-transitory computer readable medium of claim 17, wherein:
the medium further stores computer readable program code that when executed causes the one or more processors to receive a query for determined features or feature sets stored in the feature store; and
the computer readable program code that when executed causes the one or more processors to output the at least some of the one or more determined features or feature sets or the data associated with the at least some of the one or more determined features or feature sets comprises:
computer readable program code that when executed causes the one or more processors to output any determined features or feature sets matching one or more criteria specified in the query or data associated with any determined features or feature sets matching the one or more criteria specified in the query.

21. The non-transitory computer readable medium of claim 17, wherein the medium further stores computer readable program code that when executed causes the one or more processors to:
determine whether portions of the specified data are associated with different time intervals; and
resample at least one portion of the specified data to time intervals associated with at least one other portion of the specified data.

22. The non-transitory computer readable medium of claim 17, wherein:
the computer readable program code that when executed causes the one or more processors to use the metadata to determine the one or more features or feature sets for the specified data comprises:
computer readable program code that when executed causes the one or more processors to perform one or more in-memory transformations; and
the computer readable program code that when executed causes the one or more processors to store the one or more determined features or feature sets comprises:
computer readable program code that when executed causes the one or more processors to store the one or more determined features or feature sets in a feature cache of the feature store.

23. The non-transitory computer readable medium of claim 17, wherein the medium further stores computer readable program code that when executed causes the one or more processors to:
identify one or more additional transformations to be applied in order to generate one or more additional features or feature sets;
generate additional metadata identifying the one or more additional features or feature sets and the one or more additional transformations;
use the additional metadata to determine the one or more additional features or feature sets for additional specified data;
store the one or more determined additional features or feature sets in the feature store; and
output at least some of the one or more additional determined features or feature sets or data associated with the at least some of the one or more additional determined features or feature sets from the feature store.
